(19) United States
(12) Patent Application Publication
(10) Pub. No.: US 2017/0015243 A1
(43) Pub. Date: Jan. 19, 2017

(54) METHOD AND SYSTEM FOR WARNING A DRIVER OF A VEHICLE

(71) Applicant: Robert Bosch GmbH, Stuttgart (DE)

(72) Inventors: Simon Geisler, Beilstein (DE); Christian Jeschke, Beilstein (DE)

(21) Appl. No.: 15/207,987

(22) Filed: Jul. 12, 2016

(30) Foreign Application Priority Data
Jul. 17, 2015 (DE) 102015213526.8

(51) Int. Cl. B60Q 9/00

(52) U.S. Cl. CPC B60Q 9/008

(57) ABSTRACT

A method for warning a driver of a vehicle. The method includes a step of opening a communication channel between a traffic management facility and a communication unit of the vehicle when a present travel of the vehicle is identified as travel in the wrong direction.

### CROSS REFERENCE

The present application claims the benefit under 35 U.S.C. §119 of German Patent Application No. DE 102015213526.8 filed on Jul. 17, 2015, which is expressly incorporated herein by reference in its entirety.

### BACKGROUND INFORMATION

The present invention is directed to a system for warning a driver of a vehicle. The subject matter of the present invention is also a computer program.

Wrong-way drivers, so-called ghost drivers, cause fatalities, injuries and considerable property damage in the case of an accident. More than 50% of the wrong-way driving incidents begin at interchanges of the German Federal Freeways (BAB). In particular in the case of wrong-way driving on freeways, accidents occur at high collision velocity and consequently frequent injuries resulting in fatalities. At over 50%, the share of intentional wrong-way driving incidents is in particular very high. Simple warning strategies are often insufficient for pointing out the current danger situation, since wrong-way driving incidents having a background of intentionality are frequently caused by confused or drug-influenced persons.

### SUMMARY

Against this background, the present invention provides a method for warning a driver of a vehicle, furthermore a system that uses this method, as well as finally an appropriate computer program. Advantageous refinements of and improvements on the system are described herein.

A method for warning a driver of a vehicle when an incident of wrong-way driving of the vehicle has been detected contains an opening of a communication channel between a traffic management facility and a communication unit of the vehicle.

The approach provided here makes it possible to address a vehicle driver directly who drives in the wrong direction on purpose or in a confused state, or to bring the driver into direct contact with a contact partner, in order to avoid accidents having serious consequences, at best before the wrong-way driver is located on the wrong roadway of, for example, a federal expressway, at high velocity and with a high probability of a collision.

A method for warning a driver of a vehicle is provided, the method including the following step:

Opening a communication channel between a traffic management facility and a communication unit of the vehicle when a current travel of the vehicle is identified as travel in the wrong direction.

In order to warn the driver of the vehicle, the driver may be addressed directly via the opened communication channel, for example, either via an automatically generated voice message or via establishing contact by a human contact partner. The communication channel may be understood to be a data transmission device for transmitting data between the traffic management facility and the communication unit of the vehicle. For example, the communication channel may be a radio channel, which may be opened for providing a radio interface between the communication unit of the vehicle and the traffic management facility. The traffic management facility may be understood to be a central location remote from the vehicle for regulating and influencing road traffic. The communication unit of the vehicle may be a device assigned to the vehicle for communication with the traffic management facility, for example a navigation device of the vehicle or a mobile telephone of the driver of the vehicle.

This method for warning a driver of a vehicle may be implemented in, for example, software or hardware or in a mixed form of software and hardware, for example, in a control unit.

According to one specific embodiment, the method may include a step of identifying the current travel of the vehicle as travel in the wrong direction. Wrong-way driving may, for example, be identified with the aid of a comparison of information of the vehicle and information of a server communicating with the vehicle and/or the traffic management facility concerning an assumption of wrong-way driving of the vehicle.

According to one specific embodiment, the method may include a step of providing a voice message to the vehicle via the communication channel. The voice message may in particular be understood to be an automatically generated voice message. Advantageously, using this form of contacting the driver makes it possible to warn the driver with a very short time delay after identification of the wrong-way driving.

For this purpose, the voice message may be output to the vehicle driver in the vehicle. The voice message may be output, for example, via a speaker of a navigation device of the vehicle or a mobile telephone of the driver. In this way, it may be ensured that the warning reaches the driver without any action on the part of the driver.

Moreover, the method may include a step of opening another communication channel suitable for voice transmission between a control center and the communication unit of the vehicle. The control center may be, for example, assigned to the police or the civil emergency service and thus provide a qualified person for communication with the wrong-way driver.

It is also favorable if the method includes a step of transmitting a current geographic position of the vehicle to the control center via the additional communication channel. This makes it possible to influence the wrong-way driver via the control center in an even more targeted manner.

The approach provided here further creates a system, which is designed for carrying out, activating or implementing the steps of a variant of the method provided here in appropriate facilities. This embodiment variant of the present invention in the form of a system also makes it possible to achieve the object underlying the present invention quickly and efficiently. The system may be assigned to the communication unit of the vehicle and/or to the traffic management facility.

The units of the system may in the present case be understood to be electrical devices, which process sensor signals and output control and/or data signals as a function of this. The units may have interfaces, which may be designed as hardware and/or software. In the case of a hardware design, the interfaces may, for example, be part of a so-called system-ASIC, which contains very diverse functions of the device. It is, however, also possible that the interfaces are independent, integrated circuits or are at least partially made up of discrete components. In the case of a software design, the interfaces may be software modules, which, for example, are present on a microcontroller in addition to other software modules.

Also of advantage is a computer program product or computer program having program code, which may be stored on a machine-readable medium or storage medium such as a semiconductor memory, a hard drive memory or an optical memory, and is used for carrying out, implementing and/or activating the steps of the method according to one of the above-described specific embodiments, in particular if the program product or program is executed on a computer or a device or a unit.

Exemplary embodiments of the present invention are represented in the figures and are explained in greater detail below.

### BRIEF DESCRIPTION OF THE DRAWINGS

FIG. 1 shows a schematic representation of a system for warning a driver of a vehicle according to one exemplary embodiment.

FIG. 2 shows a schematic representation of a server-client communication of a system for warning a driver of a vehicle according to one exemplary embodiment.

FIG. 3 shows a flow chart of a method for warning a driver of a vehicle according to one exemplary embodiment.

### DETAILED DESCRIPTION OF EXAMPLE EMBODIMENTS

In the following description of favorable exemplary embodiments of the present invention, identical or similar reference numerals are used for the elements shown in the different figures and elements acting in a similar way, a repeated description of these elements being omitted.

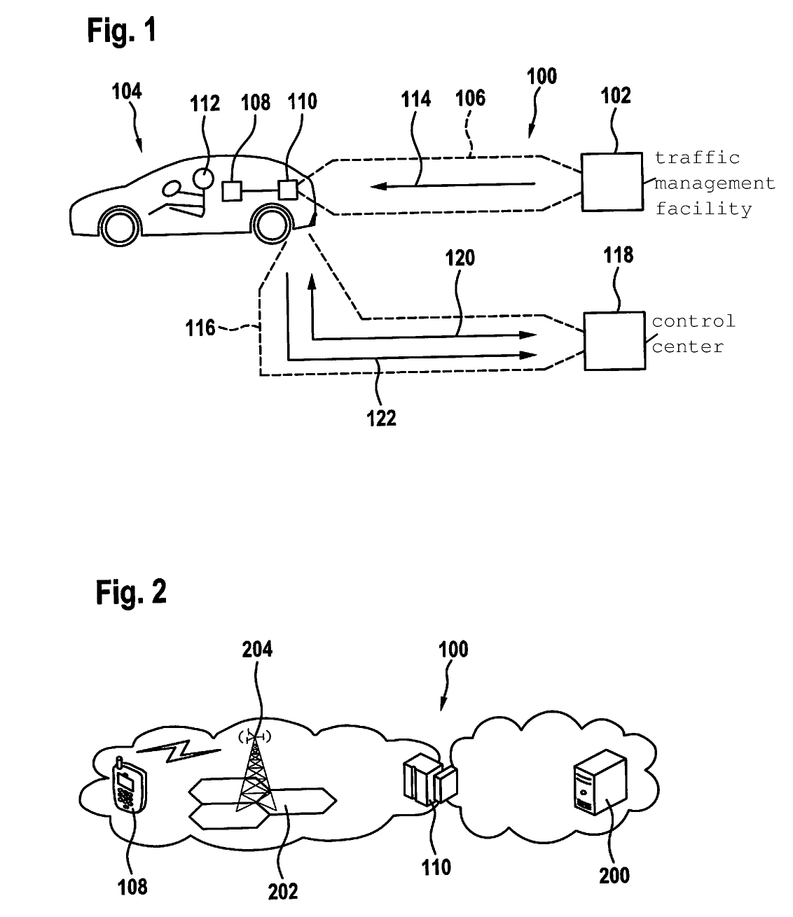

FIG. 1 shows a schematic representation of a system 100 for warning a driver of a vehicle according to one exemplary embodiment. Exemplary system 100 makes wrong-way driver detection possible using a client-server approach and offers a possibility for communicating with a driver of the vehicle. Exemplary system 100 shown in FIG. 1 includes a traffic management facility 102 and a vehicle 104.

Traffic management facility 102 is situated and designed remote from vehicle 104, in order to regulate traffic flows in a traffic area including vehicle 104. Traffic management facility 102 has a server (not shown) for collecting and processing traffic data from the assigned traffic area and additional data such as weather data. Traffic management facility 102 is connected to a communication unit 108 of vehicle 104 via a communication channel 106.

Communication channel 106 is a data transmission device for transmitting data between vehicle 104 and traffic management facility 102. Exemplary communication channel 106 shown in FIG. 1 makes wireless data transmission possible, in this case via radio. To open communication channel 106, an interface 110—in this case, a radio interface 110—is provided on vehicle 104.

In the exemplary embodiment in FIG. 1, communication unit 108 is a mobile device 108, which is assigned to an occupant 112 of vehicle 104. In the scenario illustrated in FIG. 1, occupant 112 is a driver 112 of vehicle 104. Mobile device 108 has a speaker and, if necessary, a microphone. Mobile device 108 may be, for example, a smart phone or a tablet computer of occupant 112. Alternatively, for example, a navigation device of vehicle 104 or an on-board control unit may form communication unit 108. Interface 110 may be part of communication unit 108 or integrated separately into vehicle 104.

Vehicle 104 or communication unit 108 of vehicle 104 communicates as a client with the server of traffic management facility 102 via radio interface 110. Vehicle 104 is a road-bound vehicle such as a passenger car or truck. In contrast to what is shown in FIG. 1, traffic management facility 102 is connected, in addition to vehicle 104, to still other vehicles moving in the traffic space or to their communication units.

According to the approach provided here, communication channel 106 between traffic management facility 102 and communication unit 108 of vehicle 104 is opened, when a current travel of vehicle 104 is identified as travel in the wrong direction.

For identifying the travel in the wrong direction of travel, according to one exemplary embodiment, vehicle-side wrong-way driver information is compared with server-side wrong-way driver information in the server of traffic management facility 102 using a suitable algorithm, in order to identify an assumed instance of wrong-way driving of vehicle 104 as an actual instance of wrong-way driving. For generating the vehicle-side wrong-way driver information, for example, measuring data of a sensor system of vehicle 104 and position data of vehicle 104 are used. For generating the server-side wrong-way driver information, if necessary, data of other vehicles stored in the server of traffic management facility 102 and information from additional databases are used.

If wrong-way driving of vehicle 104 is verified and communication channel 106 is opened, according to one exemplary embodiment of the present invention provided here, a voice message 114 is provided to communication unit 108 in vehicle 104 via communication channel 106. Voice message 114 may be prepared in automated form in traffic management facility 102. Via a speaker of communication unit 108, in this case of mobile device 108 of driver 112, voice message 114 is provided to driver 112 of vehicle 104 as spoken text in the form of a warning concerning the wrong-way driving.

Instead of the text form or in addition, the warning according to exemplary embodiments is also provided as an alarm sound or warning light.

According to one exemplary embodiment of system 100 presented here, in response to a detected instance of wrong-way driving of vehicle 104, in addition to communication channel 106, an additional communication channel 116 between communication unit 108 of vehicle 104 and a control center 118 is opened via an additional interface which is not shown in FIG. 1.

In the case of the exemplary embodiment shown in FIG. 1, additional communication channel 116 is a wireless data transmission device for radio traffic between vehicle 104 and control center 118. In the case of an identified instance of wrong-way driving of vehicle 104, according to one exemplary embodiment, a telephone connection without caller identity, if necessary, is established between mobile device 108 of driver 112 of vehicle 104 and control center 118, in order to be able to communicate directly with driver 112 via a human contact person.

According to exemplary embodiments, control center 118 may be a police operations center, an emergency service or another institution, which has trained personnel for advising wrong-way driver 112. It is thus possible to make a contact person available to driver 112 of vehicle 104, who is able to influence driver 112 in a direct dialog 120 with driver 112 via additional communication channel 116 for the purpose of avoiding a collision.

For improved collision avoidance, according to another exemplary embodiment, a current geographic position 122 of vehicle 104 is transmitted to control center 118 via additional communication channel 116.

The last-mentioned embodiment of the present invention provided here proves to be particularly practical and helpful, since surveys carried out indicate that more than 50% of all instances of wrong-way driving have a background of intentionality. In the case of intentional instances of wrong-way driving, which are caused, for example, by confused or drug-influenced persons, usual warning strategies show no effect. In this case, only with the aid of the establishment of direct contact with wrong-way driver 112 may a collision possibly be prevented.

FIG. 2 shows a schematic representation of a wrong-way driver-specific server-client communication of an exemplary embodiment of system 100 for warning a driver of a vehicle from FIG. 1. For the wireless communication with a server 200 of a traffic management facility, which is not shown in FIG. 2, a mobile device assigned to an occupant of the vehicle, in this case a smart phone 108, is again used as communication device 108 of the vehicle representing a client unit of system 100.

While the vehicle is in travel, smart phone 108 moves through various radio cells 202 of its mobile phone provider 204, which is indicated in the representation in FIG. 2 with the aid of a radio tower. Vehicle-server interface or client-server interface 110 between client 108 and server 200 is formed here by a PDN gateway 110.

Mobile device 108 used as a client device is located on or in a motor vehicle, which has an Internet connection and at least access to position coordinates.

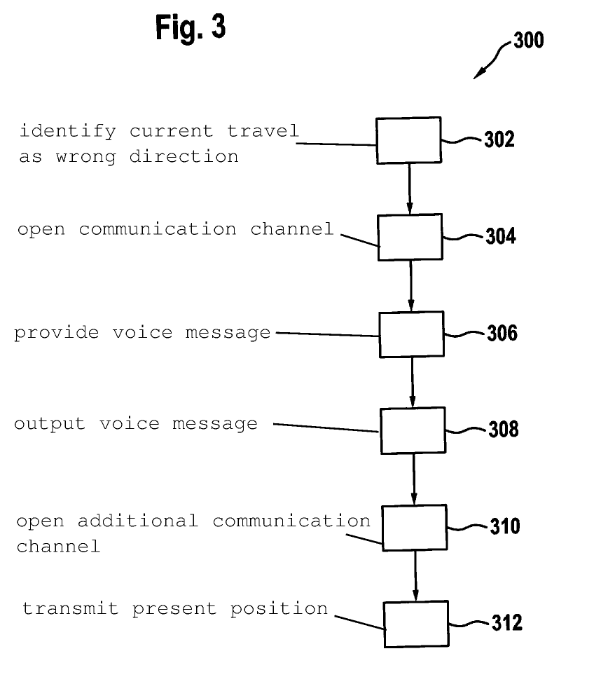

FIG. 3 shows a flow chart of an exemplary embodiment of a method 300 for warning a driver of a vehicle. Method 300 may be carried out by an exemplary embodiment of the system shown in FIGS. 1 and 2 for warning a driver of a vehicle.

In a step of identifying 302, a current travel of the vehicle is identified as travel in the wrong direction. In a step of opening 304, in response to the identification of wrong-way driving, a communication channel is opened between a traffic management facility remote from the vehicle and a communication unit of the vehicle, in order to provide a voice message to the vehicle via the communication channel in a subsequent step of providing 306. In a subsequent step of outputting 308, the voice message is output to the driver of the vehicle via a speaker in the vehicle.

According to one exemplary embodiment, method 300 for implementing a warning strategy after a detection of wrong-way driving has a step of opening 310 an additional communication channel or voice channel between a control center and the communication unit of the vehicle as well as a step of transmitting 312 a present geographic position of the vehicle to the control center via the additional communication channel.

Step 302 of detecting wrong-way driving via a client, steps 304, 306, 308 for outputting an automatically generated voice message and step 310 of automatically opening a voice channel using an, if necessary, suppressed emergency call number or road traffic management center, as well as, if necessary, step 312 for transmitting the location or position of the vehicle, need not necessarily be implemented in the present sequence.

If an exemplary embodiment includes an “and/or” linkage between a first feature and a second feature, this is to be read in such a way that the exemplary embodiment of one specific embodiment has both the first feature and the second feature and according to one further specific embodiment has either only the first feature or the second feature.

What is claimed is:

1. A method for warning a driver of a vehicle, the method comprising:
opening a communication channel between a traffic management facility and a communication unit of the vehicle when a present travel of the vehicle is identified as travel in a wrong direction.

2. The method as recited in claim 1, further comprising:
identifying the present travel of the vehicle as travel in the wrong direction.

3. The method as recited in claim 1, further comprising:
providing a voice message to the vehicle via the communication channel.

4. The method as recited in claim 3, further comprising:
outputting the voice message in the vehicle to a driver of the vehicle.

5. The method as recited in claim 1, further comprising:
opening another communication channel suitable for voice transmission between a control center and the communication unit of the vehicle.

6. The method as recited in claim 5, further comprising:
transmitting a present geographic position of the vehicle to the control center via the additional communication channel.

7. A system for warning a driver of a vehicle, the system configured to open a communication channel between a traffic management facility and a communication unit of the vehicle when a present travel of the vehicle is identified as travel in a wrong direction.

8. A machine-readable storage medium on which is stored a computer program for warning a driver of a vehicle, the computer program, when executed by a processing unit, causing the processing unit to perform:
opening a communication channel between a traffic management facility and a communication unit of the vehicle when a present travel of the vehicle is identified as travel in a wrong direction.
